(19) United States
(12) Patent Application Publication
(10) Pub. No.: US 2006/0139560 A1
(43) Pub. Date: Jun. 29, 2006

(54) Liquid crystal panel and method for manufacturing same

(75) Inventors: Jen-Lang Tung, Kaohsiung City (TW); Hao-Yu Chang, Jhubei City (TW); Jung-Hsiang Lin, Taichung City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: AU Optronics Corp.

(21) Appl. No.: 11/224,756

(22) Filed: Sep. 13, 2005

(30) Foreign Application Priority Data
Dec. 23, 2004 (TW) 93140227

(51) Int. Cl. G02F 1/1339

(52) U.S. Cl. 349/155

(57) ABSTRACT

A method for manufacturing a liquid crystal panel is disclosed. A mixture of liquid crystal and a solidifying material is dropped on a first substrate. A second substrate is provided such that the mixture is disposed between the first substrate and the second substrate. The solidifying material is solidified to connect the first and second substrates.

### BACKGROUND

The present invention relates to a liquid crystal panel, and in particular, to a liquid crystal panel and a manufacturing method thereof.

FIG. 1A is a cross section of the internal structure of a conventional liquid crystal panel 10. The liquid crystal panel 10 comprises an upper substrate 11 and a lower substrate 12. The upper substrate 11 includes a color filter with color pixel regions and black matrix regions (not shown) formed thereon. The lower substrate 12 includes a TFT substrate, and a liquid crystal layer is disposed between the upper and lower substrates 11 and 12.

One drop fill (ODF) currently replaces more conventional liquid crystal panel manufacturing methods. In ODF, as illustrated in FIG. 1A, liquid crystal material 15 is dropped on the lower substrate 12 and a photo spacer 13 formed on the upper substrate 11. The upper and lower substrates 11 and 12 are then combined. The spacer 13 supports the upper and lower substrates 11 and 12. The volume of liquid crystal material deployed is dependent on the height of the spacer 13, and thus the gap between the upper and lower substrates 11 and 12 and the length of the spacer 13 must first be ascertained.

During a manufacturing process, the panel is generally processed under atmospheric pressure. If the total compression of the spacer 13 is too high, the processing system cannot provide sufficient height tolerance for the spacer, and the liquid crystal 15 cannot completely fill between the upper and lower substrates 11 and 12, such that air bubbles are generated therein, causing the liquid crystal panel 10 to have lower efficiency. If the total compression of the spacer 13 is not high enough, after ODF, the spacer 13 cannot sustain the weight of the liquid crystal 15, resulting in problems such as mura effect.

The traditional spacer 13 is formed on a side of the upper substrate 11, and as the size of the liquid crystal panel increases, the weight and volume thereof increases accordingly. After the liquid crystal panel is completed and positioned upright, as shown in FIG. 1B, the weight of the liquid crystal 15 deforms the substrates such that the lower substrate 12 is separated from the spacer 13. As a result, the spacer 13 cannot maintain the connection between the upper and lower substrates 11 and 12, and mura effect again occurs.

When the liquid crystal panel is placed flat, as shown in FIG. 1C, the upper substrate 11 of the liquid crystal panel 10 is subjected to an external force P and deformed downward. If the spacer 13 is not strong enough, the liquid crystal 15 may flow to both sides in a direction as indicated by the two arrows. The spacers 13a and 13b located at both edges are elevated up by the liquid crystal 15, thus causing mura effect.

### SUMMARY

Embodiments of the present invention provide a method for manufacturing liquid crystal panels, which eliminates the shortcomings described above, provides higher rigidity of the spacer after ODF, increases compression, and reduces mura effect.

The present invention further provides a method for manufacturing liquid crystal panels, which comprises forming a spacer by ultraviolet light or heat to connect two substrates simultaneously while maintaining constant distance therebetween, thereby reducing mura effect.

Another liquid crystal panel manufacturing method for connecting a first substrate and a second substrate comprises providing a solidifying material and clamping the solidifying material and liquid crystal between the first substrate and the second substrate, and solidifying the solidifying material to connect the first substrate and the second substrate.

Embodiments of the present invention further provide yet another liquid crystal panel manufacturing method for connecting a first substrate and a second substrate, comprising injecting a mixture of liquid crystal and a solidifying material onto the first substrate, clamping the mixture between the first substrate and the second substrate, and solidifying the solidifying material to connect the first substrate and the second substrate.

Embodiments of the present invention further provide a liquid crystal panel manufacturing method for connecting a first substrate and a second substrate, comprising adhering a solidifying material to the first substrate, injecting liquid crystal on the first substrate, clamping the liquid crystal between the first substrate and the second substrate, and solidifying the solidifying material to connect the first substrate and the second substrate.

Embodiments of the present invention further provide a liquid crystal panel comprising a first substrate, a second substrate, a liquid crystal layer, and a plurality of spacers. The liquid crystal layer is disposed between the first substrate and the second substrate. The spacers comprise a solidifying material with liquid crystal therein and are disposed between the first substrate and the second substrate.

### BRIEF DESCRIPTION OF THE DRAWINGS

The present invention can be more fully understood by reading the subsequent detailed description in conjunction with the examples and references made to the accompanying drawings, wherein:

FIG. 1A is a cross section of a conventional liquid crystal panel;

FIG. 1B is a cross section of a conventional liquid crystal panel positioned upright;

FIG. 1C is a cross section of a conventional liquid crystal panel placed flat;

FIG. 2A is a cross section of an embodiment of a liquid crystal panel according to the present invention;

FIG. 2B is a schematic view of a mixture dropped on the first substrate of a liquid crystal panel;

FIG. 2C is a schematic view of a mixture disposed between the first substrate and the second substrate of a liquid crystal panel according to the present invention;

FIG. 2D is a schematic view of a liquid crystal panel after spacers are formed;

FIG. 3A is a cross section of another embodiment of a liquid crystal panel according to the present invention;

FIG. 3B is a schematic view of a solidifying material adhered to the first of a liquid crystal panel;

FIG. 3C is a schematic view of liquid crystal injected between the first substrate and the second substrate of a liquid crystal panel; and

FIG. 3D is a schematic view of a liquid crystal panel after spacers are formed.

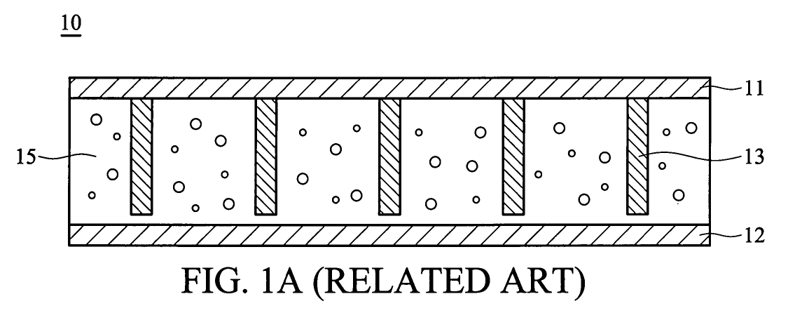

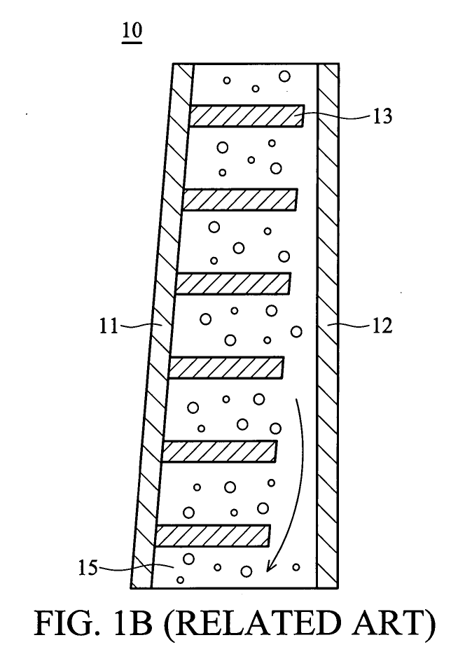

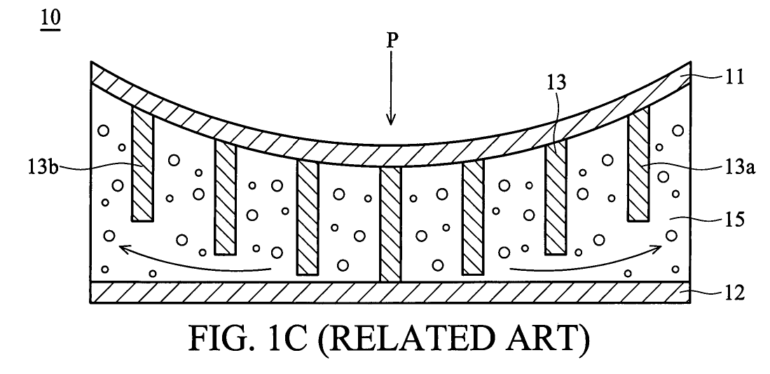

### DETAILED DESCRIPTION

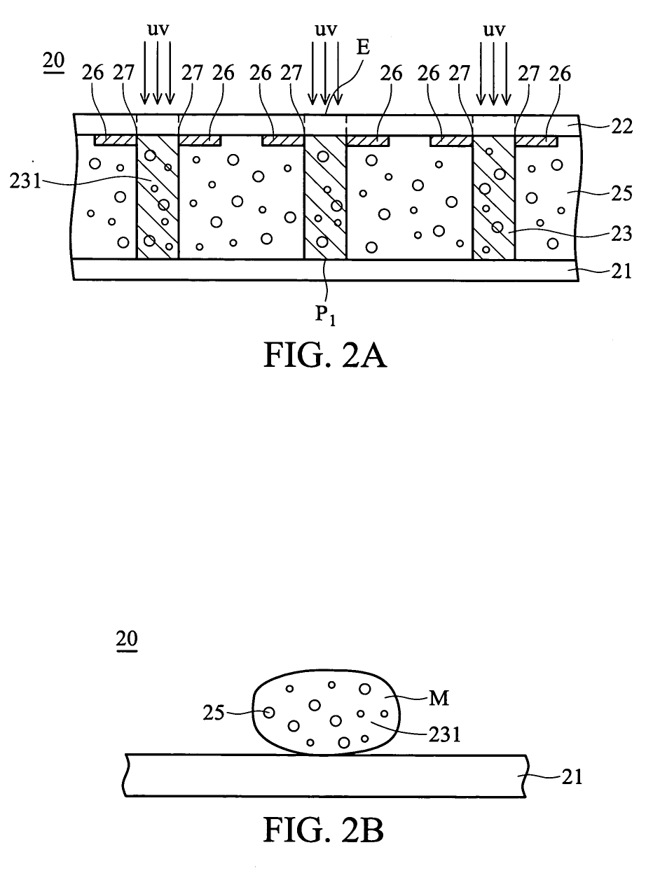

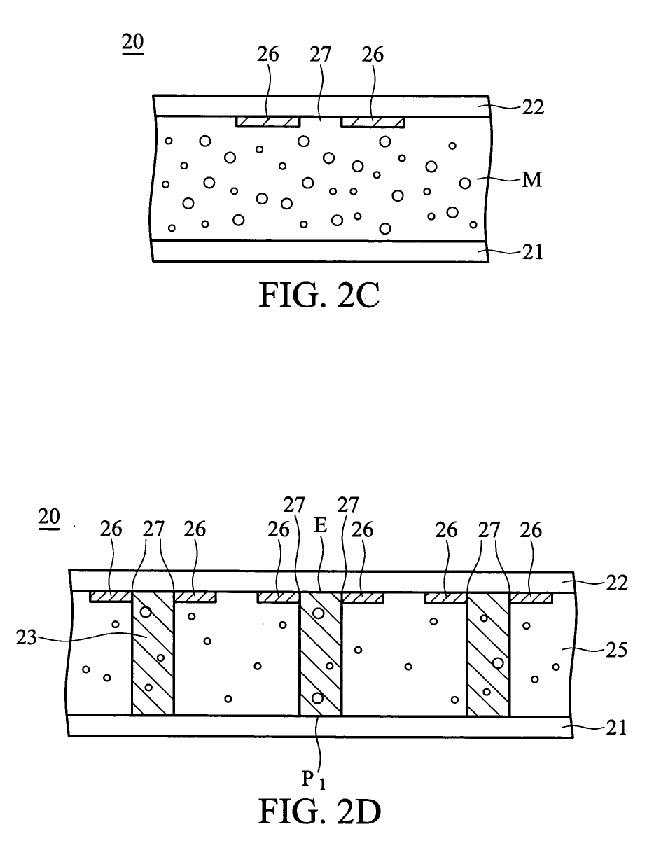

FIG. 2A is a cross section of an embodiment of a liquid crystal panel 20 manufactured by a method of the present invention. It is noted that only the panel structure is shown in FIG. 2A. The liquid crystal panel 20 comprises a first substrate 21, a second substrate 22, a liquid crystal layer 25, and a plurality of spacers 23. The liquid crystal layer 25 is disposed between the first substrate 21 and the second substrate 22. In the embodiment, the first substrate 21 includes a TFT substrate, and the second substrate 22 includes a color filter (CF) substrate, for example.

In another embodiment, the first substrate 21 includes indium tin oxide (ITO) glass, plane glass, or a combination of CF and TFT substrate, and the second substrate 22 includes a TFT substrate, a combination of CF and TFT substrate, or ITO glass. The first and second substrates are interchangeable.

The spacers 23 comprise solidifying material 231 with liquid crystal therein, and are formed between the first and second substrates 21 and 22 with a predetermined interval therebetween to connect the first and second substrates 21 and 22. FIGS. 2B to 2D are schematic views of an embodiment of the liquid crystal panel 20 during manufacture. As shown in FIG. 2B, the liquid crystal 25 is combined with the solidifying material 231, resulting in a mixture M. The mixture M is dropped on the first substrate 21. As show in FIG. 2C, the first substrate 21 is disposed opposite the second substrate 22, and the mixture M is completely filled therein. A side of the second substrate 22 has one or more shielding layers 26 with an opening 27 formed thereon. The shielding layer 26 comprises a black matrix layer, for example.

FIG. 2D is a schematic view of a liquid crystal panel 20 on which multiple spacers 23 are formed. The first substrate 21 comprises a positioning region P₁, and the second substrate 22 comprises an energy entry region E, and a transparent layer P₁. If the second substrate 22 comprises the shielding layer 26, the energy entry region E corresponds to the opening 27 of the shielding layer 26.

In another embodiment of the present invention, the energy entry region E corresponds to a metal wire (not shown) on a side of the first substrate 21, for example. During solidification, the portion of the solidifying material 231 (FIG. 2B) corresponding to the metal wire is solidified.

The solidifying material 231 comprises photosensitive or thermosetting materials such as acrylic monomer or other materials suitable for solidification. If the solidifying material 231 comprises photosensitive materials, the solidifying step is preferably performed by exposure. If the solidifying material 231 comprises thermosetting materials, the solidifying step is preferably performed by heating. Since the solidifying material 231 is a monomer, which is preferably adhesive, the first substrate 21 and the second substrate 22 are connected during the solidifying step.

Referring to FIG. 2D, since the mixture M of the solidifying material 231 and the liquid crystal is exposed or heated to form a spacer 23, the spacer 23 comprises the materials of both liquid crystal and the solidifying material. That is, the liquid crystal layer 25 comprises materials of the spacer 23.

In this embodiment, the mixture M of the solidifying material 231 and the liquid crystal is dropped on the first substrate 21. Before the solidifying step, the solidifying material 231 is soft, and hard spacers are not formed yet. Thus, the liquid crystal layer 25 is fully deposited without any undesirable air bubbles formed therein.

After ODF, the liquid crystal panel is exposed to, for example, UV light, visible light, or heated. In the exposure or heating step, the solidifying material 231 is solidified and the height of the spacer 23 determined. In the solidifying step, the spacer 23 becomes adhesive with greater rigidity such that the first substrate 21 and the second substrate 22 are connected. The spacer 23, as a result, has high rigidity and compression while preventing separation of the first substrate 21 and the second substrate 22. Additionally, since the rigidity and compression of the spacer 23 is increased after the ODF, the formation of air bubbles formed in the liquid crystal is eliminated, and therefore deformation of the substrates and the problem of mura effect are avoided.

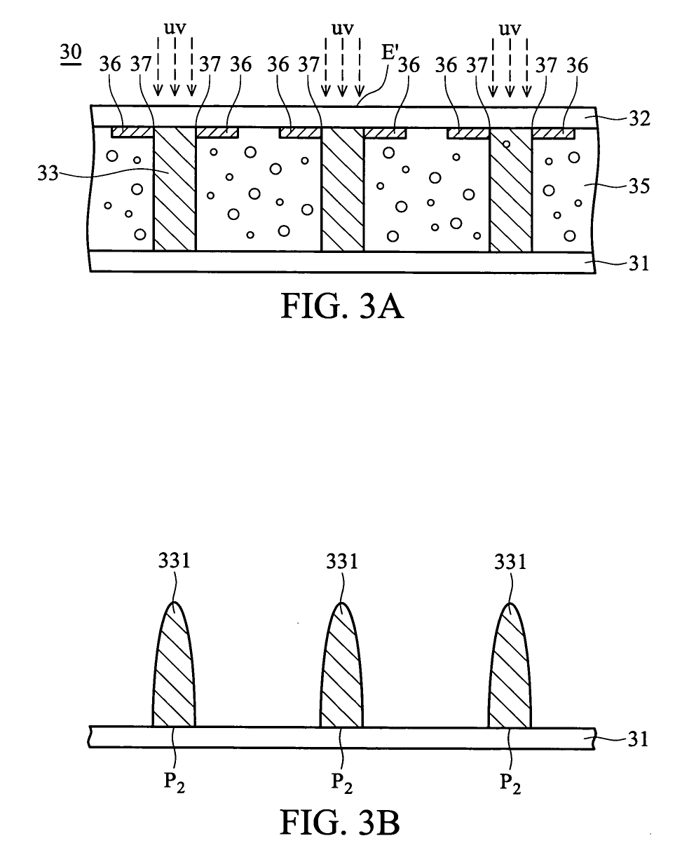

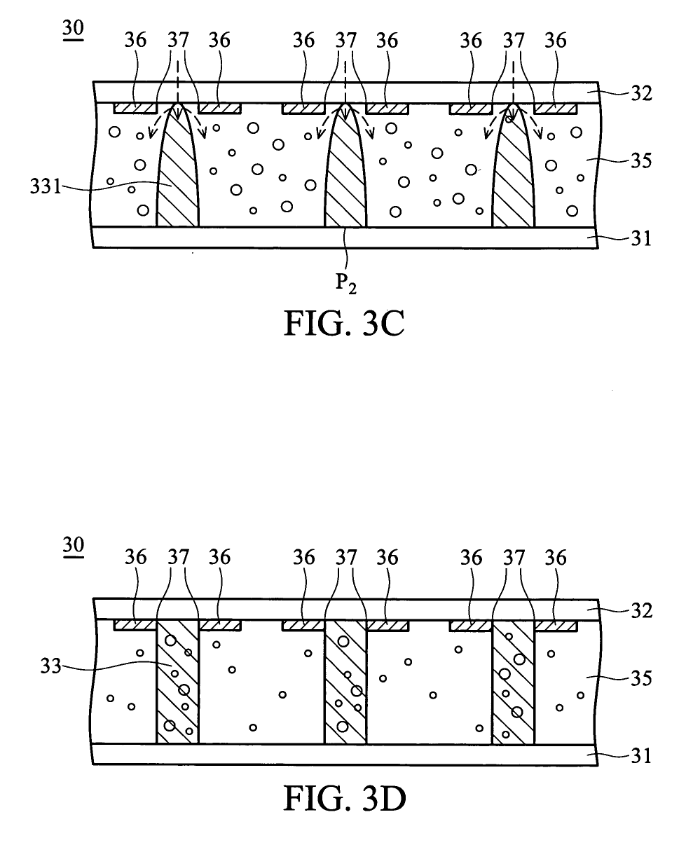

FIG. 3A is a cross section of another embodiment of a liquid crystal panel 30 manufactured by a method of the present invention. The liquid crystal panel 30 comprises a first substrate 31, a second substrate 32, a liquid crystal layer 35, and a plurality of spacers 33. The liquid crystal 35 is disposed between the first substrate 31 and the second substrate 32. In the embodiment, the first substrate 31 is a TFT substrate, and the second substrate 32 is a CF substrate, for example.

In another embodiment, the first substrate 31 is ITO glass, plane glass, or a combination of CF and TFT substrate, and the second substrate 32 a TFT substrate, a combination of CF and TFT substrate, or ITO glass. It is noted that the first and second substrates are interchangeable.

The spacers 33 comprise solidifying material 331, and are formed between the first and second substrates 31 and 22 with a predetermined interval therebetween to connect the first and second substrates 31 and 3.

FIGS. 3B to 3D are the schematic views of another embodiment of the liquid crystal panel 30 during manufacture.

In this embodiment, the first step adheres a solidifying material 331 on the first substrate 31, as shown in FIG. 3B.

In FIG. 3C, the liquid crystal is dropped on the first substrate 31, and the first substrate 31 is positioned corresponding to the second substrate 32. The liquid crystal is sealed therebetween. A side of the second substrate 32 comprises a shielding layer 36 with an opening 37. The shielding layer 36 comprises a black matrix layer.

FIG. 3D is a schematic view of a liquid crystal panel 30 after spacers 33 are formed. The first substrate 31 comprises a positioning region P₂, with the solidifying material 331 adhered thereto. The second substrate 32 comprises an energy entry region E′, corresponding to the positioning region P₂, and the energy entry region E′ can be a transparent layer. If the second substrate 32 comprises the shielding layer 36, the energy entry region E′ corresponds to the opening 37 of the shielding layer 36.

In another embodiment, the energy entry region E′ corresponds to a metal wire (not shown) on a side of the first substrate 31. During solidification, the portion of the solidifying material 331 corresponding to the metal wire is solidified.

The solidifying material 331 comprises photosensitive or thermosetting sealant materials such as acrylic resin or other material suitable for solidification. If the solidifying material 331 comprises photosensitive materials, the solidifying step is preferably performed by exposure. If the solidifying material 331 comprises thermosetting materials, the solidifying step is preferably performed by heating. Since the solidifying material 231 is sealant, which is preferably adhesive, the first substrate 31 and the second substrate 32 are connected in the solidifying step.

After the ODF, the liquid crystal panel is exposed to, for example, UV light, visible light, or heated. In the exposure or heating, the solidifying material 331 is solidified while producing adhesive with greater rigidity to connect the first and second substrates 31 and 32. The spacer 33, thus, has high rigidity and compression while preventing separation of the first substrate 21 and the second substrate 22. Additionally, since the rigidity and compression of the spacer 33 is increased after ODF, the problem associated with air bubbles formed in the liquid crystal is eliminated, thereby preventing deformation of the substrates and generation of mura effect.

While the present invention has been described by way of example and in terms of preferred embodiments, it is to be understood that the present invention is not limited thereto. Rather, it is intended to cover various modifications and similar arrangements as would be apparent to those skilled in the art. Therefore, the scope of the present invention as defined by the appended claims should be accorded the broadest interpretation so as to encompass all such modifications and similar arrangements.

What is claimed is:

1. A method for manufacturing a liquid crystal panel having a first substrate and a second substrate, comprising:
providing a solidifying material;
clamping the solidifying material and liquid crystal between the first substrate and the second substrate; and
solidifying the solidifying material to connect the first substrate and the second substrate.

2. The method as claimed in claim 1, wherein the solidifying material comprises a photosensitive material or a thermosetting material.

3. The method as claimed in claim 1, further comprising disposing a shielding layer with an opening formed thereon before the solidifying step on the second substrate, wherein the solidifying material is solidified through the opening.

4. The method as claimed in claim 1, wherein the second substrate comprises an energy entry region, and the solidifying material is solidified by exposing to light through the energy entry region.

5. The method as claimed in claim 1, wherein after the solidifying material is mixed with the liquid crystal, the mixture is dropped onto the first substrate.

6. The method as claimed in claim 1, wherein the first substrate comprises a thin film transistor (TFT) substrate, a color filter (CF) substrate, an indium-tin-oxide (ITO) glass substrate, or combinations thereof.

7. A method for manufacturing a liquid crystal panel having a first substrate and a second substrate, comprising:
injecting a mixture of liquid crystal and a solidifying material onto the first substrate;
clamping the mixture between the first substrate and the second substrate; and
solidifying the solidifying material to connect the first substrate and the second substrate.

8. The method as claimed in claim 7, wherein the first substrate comprises a thin film transistor (TFT) substrate, a color filter (CF) substrate, an indium-tin-oxide (ITO) glass substrate, or combinations thereof.

9. The method as claimed in claim 7, wherein the first substrate comprises a positioning region, and the second substrate comprises an energy entry region, corresponding to the positioning region, and spacers are formed by the solidifying material between the positioning region and the energy entry region.

10. The method as claimed in claim 7, further comprising providing a shielding layer with an opening thereon before solidifying, the shielding layer being disposed on the second substrate, wherein the solidifying material is solidified through the opening.

11. The method as claimed in claim 10, wherein the shielding layer comprises a black matrix layer.

12. The method as claimed in claim 10, wherein the shielding layer comprises a metal wire.

13. A method for manufacturing a liquid crystal panel having a first substrate and a second substrate, comprising:
adhering a solidifying material to the first substrate;
injecting liquid crystal onto the first substrate;
clamping the liquid crystal between the first substrate and the second substrate; and
solidifying the solidifying material to connect the first substrate and the second substrate.

14. The method as claimed in claim 13, wherein the first substrate comprises a thin film transistor (TFT) substrate, a color filter (CF) substrate, an indium-tin-oxide (ITO) glass substrate, or combinations thereof.

15. The method as claimed in claim 13, wherein the first substrate comprises a positioning region, and the second substrate comprises an energy entry region, corresponding to the positioning region, and the solidifying material is disposed on the positioning region with spacers formed between the positioning region and the energy entry region.

16. The method as claimed in claim 13, further comprising providing a shielding layer with an opening thereon before solidifying, the shielding layer being disposed on a side of the second substrate, wherein the solidifying material is solidified through the opening.

17. The method as claimed in claim 13, wherein the shielding layer comprises a black matrix layer.

18. The method as claimed in claim 13, wherein the shielding layer comprises a metal wire.

19. A liquid crystal panel, comprising:
a first substrate;
a second substrate;
a liquid crystal layer disposed between the first substrate and the second substrate; and
a plurality of spacers, disposed between the first substrate and the second substrate, comprising a solidifying material with liquid crystal therein.

20. The liquid crystal panel as claimed in claim 19, wherein the first substrate comprises a thin film transistor (TFT) substrate, a color filter (CF) substrate, an indium-tin-oxide (ITO) glass substrate, or combinations thereof.

21. The liquid crystal panel as claimed in claim 19, wherein the liquid crystal layer comprises materials of the spacer.
